(19) United States
(12) Patent Application Publication
(10) Pub. No.: US 2002/0091993 A1
(43) Pub. Date: Jul. 11, 2002

(54) Contextual help information

(75) Inventors: Christopher Michael Walley, Christchurch (NZ); Baskar Vedachalam, BroadMeadows (NZ)

Correspondence Address: Gregory M. Doudnikoff, IBM Corporation T81/503, PO Box 12195, Research Triangle Park, NC, 27709, US

(73) Assignee: International Business Machines Corporation, Armonk, NY

(21) Appl. No.: 09/968,728

(22) Filed: Sep. 28, 2001

(30) Foreign Application Priority Data
Sep. 29, 2000 (NZ) 507253

(51) Int. Cl. G06F 9/44

(52) U.S. Cl. 717/120

(57) ABSTRACT

This invention relates to a computer application and method for providing a user with help information during operation of a computer application. An operation of a function performed by a user is detected and a location reference to a stored document containing help information relating to the operation is determined. The document is retrieved from the storage location and then displayed to the user.

### BACKGROUND OF THE INVENTION

1. Field of the Invention

This invention relates to providing help information for an application. In particular it relates to providing contextual help pages according to the features or functions of the application that are being used.

2. Description of the Related Art

Computer applications typically include online help which provides a user with information relating to the features provided by the application. This can assist the user in learning how to use the application. For example, when using a word processing program, the user can consult help information by accessing a help menu and typing in a keyword relating to the feature they wish to learn about.

Receiving help information in this manner is not always efficient or convenient. It requires the user to interrupt their usage of the application to access the help menu. They must then find the relevant help page using the contents, index or other navigation facilities provided by the help system. This can result in an undesirable delay before the user identifies the particular help page they require which relates to the feature they are using.

Therefore, it would be desirable to provide a contextual help system which identifies, retrieves and displays relevant help pages as a user operates an application.

### SUMMARY OF THE INVENTION

It is an object of the invention to provide a method, computer software, or computer readable medium containing computer code for providing help pages according to the functions of an application which are being used. In general terms, the invention monitors the actions of a user when operating an application, determines the storage location of relevant help information based on the action performed and other parameters, retrieves the help information from the storage location and then displays the help information.

In a preferred embodiment, contextual help is provided in a computer application such as a database tutorial program. The application determines a number of parameters relating to the features of the application which are currently being used and combines this with one or more other user specified parameters. This information is combined and used to identify a relevant help document from a look up table. Once identified, the relevant pages are retrieved from a document store and displayed to the user in a browser.

In one aspect, the present invention comprises a method for providing a user with help information during operation of a computer application, which includes the steps of detecting operation of a function of the application by the user, determining a location reference to a stored document containing help information relating to the function, retrieving the document from a storage location using the reference, and displaying content from the document.

Another aspect of the present invention comprises computer software adapted to provide a user with help information during operation of the application, the software including a monitoring facility for detecting operation of an application function by the user, a reference generator for determining a location reference to a stored document containing help information relating to the function, a retrieval function for retrieving the document from a storage location using the reference, and a graphical interface for displaying content from the document.

Yet another aspect of the present invention comprises a computer readable medium containing computer code for an application which provides a user with help information, the code enabling the steps of detecting operation of an application function by the user, determining a location reference to a stored document containing help information relating to the function, retrieving the document from its storage location using the reference, and displaying content from the document.

The invention may also broadly be said to consist in any alternative combination of features as described or shown in the accompanying drawings. Known equivalents of these features not expressly set out are nevertheless deemed to be included.

### BRIEF DESCRIPTION OF THE DRAWINGS

The invention will be described with respect to the accompanying drawings, of which:

FIG. 1 schematically shows a client/server system for implementing software to provide a tutorial for an application along with a client browser for displaying contextual help pages relating to the tutorial;

FIG. 2 outlines a process for retrieving contextual help pages from a server for display in the client browser;

FIG. 3 outlines Step 23 of the process in more detail;

FIG. 4 outlines Step 26 of the process in more detail;

FIG. 5 shows an example profile table for determining a reference to a relevant contextual help page for display;

FIGS. 6a and 6b are a screen capture showing an introduction page of an example database tutorial and a browser page displaying a corresponding full tutorial help page;

FIGS. 7a and 7b are a screen capture showing another page of the database tutorial with a corresponding help page guiding the user to operate the tutorial;

FIGS. 8a and 8b are a screen capture showing an incorrect selection and a corresponding error message displayed in the browser;

FIGS. 9a and 9b are a screen of a selection form and a corresponding help page;

FIG. 10 is a screen capture of a help page displayed when an incorrect selection has been made;

FIG. 11 is a screen capture showing an introduction page of an example database tutorial in self check mode;

FIGS. 12a and 12b are a screen capture showing another page of the database tutorial with a corresponding self check help page; and

FIG. 13 schematically shows hardware for implementing the invention.

### DESCRIPTION OF THE PREFERRED EMBODIMENTS

Referring to the drawings, it will be appreciated that the invention can be implemented to provide contextual help for an application in various forms. The following embodiments are given by way of example only. It will also be appreciated that while the description relates to a database tutorial application, the invention could be implemented in respect of any computer application in which help is provided.

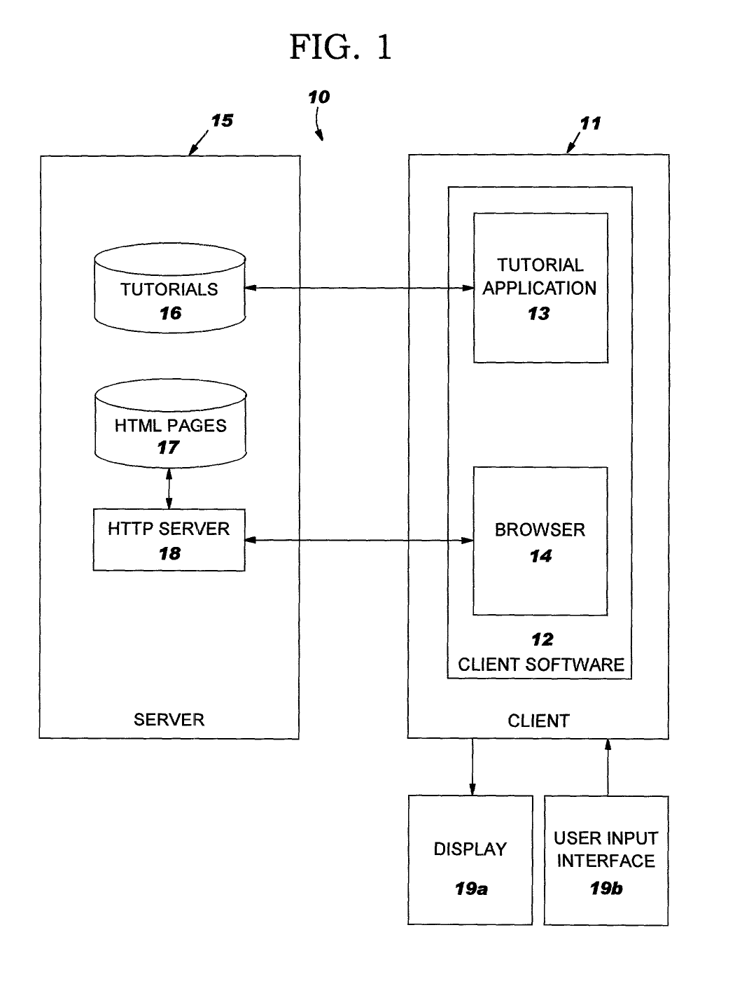

FIG. 1 shows schematically a preferred system in which contextual help pages are provided to a user throughout use of a database tutorial application. The system 10 includes one or more client workstations or terminals 11 running client software 12 which includes a tutorial application 13 and a help page display browser 14. The tutorial application 13 is adapted to simulate a database system to assist in the training of database users. The browser 14 is preferably a separate application from the tutorial application 13 and is capable of displaying documents which are defined in an HTML format. However, it will be appreciated that any display means could be used to display help documents in any suitable format well known in the art. For example, the browser 14 could be a word processor or text editor which displays help pages stored in a standard text format.

The client terminal 11 is linked to a server 15 via any suitable communications network, such as an intranet or the Internet. The server 15 provides a database 16 of tutorials for use with the tutorial application 13 and a database 17 of help pages or the like stored in HTML or other format of this general kind, such as XML. HTML pages from the database 17 are supplied to the browser 14 via a HTTP server 18. During operation of the tutorial application 13, the application 13 determines relevant help documents based on various factors, and a location reference pointing to the relevant document is sent to the browser 14 as required. The browser 14 then uses the reference to retrieve a contextual help page or pages from the database 17. A user interface including a display monitor 19a and keyboard, mouse and other user input devices 19b is also provided.

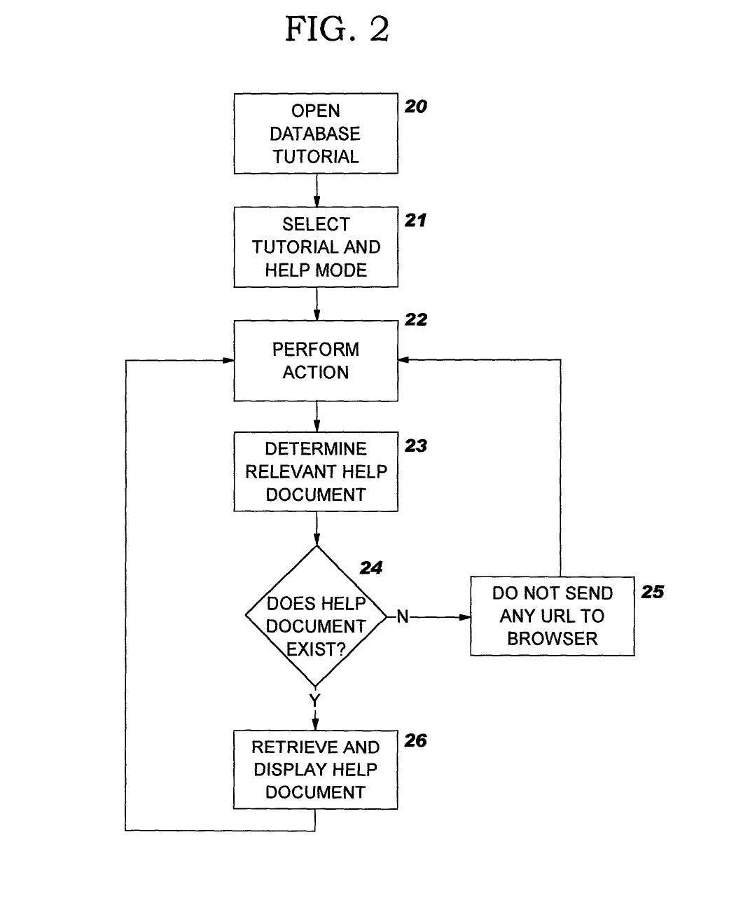

FIG. 2 outlines a general process for providing contextual help pages during operation of a computer application such as the database tutorial application 13. The user starts the tutorial application (Step 20) and selects a tutorial (Step 21) to operate, at which point the tutorial application retrieves tutorial files from the database 16. The user also selects in Step 21 the type of help required, which is one choice from various options, each option providing a different type of help. For example, in the preferred embodiment the user gets to choose from a “full tutorial” help mode which provides in-depth help instructions as the user progresses through the tutorial application, or alternatively a “self check” mode which provides minimal help only when the user carries out an incorrect action. It will be appreciated that any suitable number of help modes could be provided as required, each providing a different nature of help. The selected help mode and tutorial type is stored in a user profile file. The profile file may be stored on the system 10 any suitable manner known to a person skilled in the art.

Once the application 13 is executed, the user operates the features or functionality of the application in the usual manner as required. The application 13 monitors this user operation of the features and functionality. Each time the application 13 detects that a user has performed an action (Step 22), it retrieves or determines a reference (Step 23) to a location of a stored document which contains help information relating to the action. If the application 13 determines that no such document exists (Step 24) in the database 17, then no help is displayed and the application 13 continues to operate in the usual manner (Step 25). However if a help document for the action does exist then the HTML pages are retrieved from the database 17 and displayed in the browser 14 (Step 26).

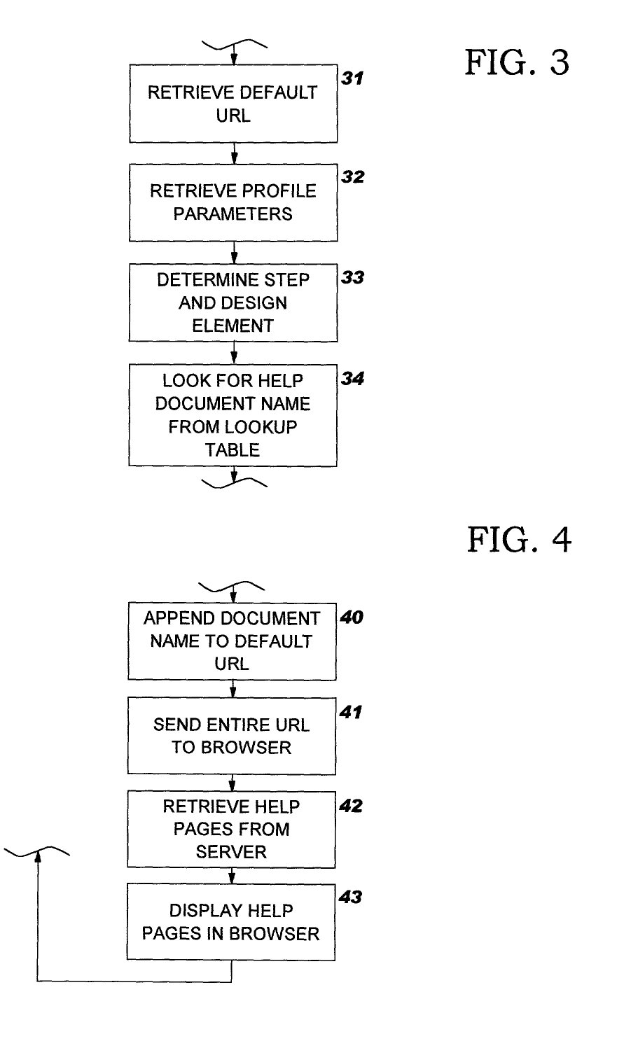

FIGS. 3 and 4 outline in more detail Steps 23 and 25, respectively, of FIG. 2. In particular, these figures outline the preferred method used to determine a reference to a relevant help document and retrieval of the document. The reference is preferably a universal resource locator (URL) pointing to one or more documents which can be accessed via an intranet or the Internet. However, it will be appreciated that the reference could be of any nature which specifies the location of a document in a computer system such as a filename of a file stored on a network device. As the user operates the tutorial application 13, each action they perform progresses them through the steps of the tutorial. Each step is displayed in a design element of the application, such as a document form, window, or other graphical user interface.

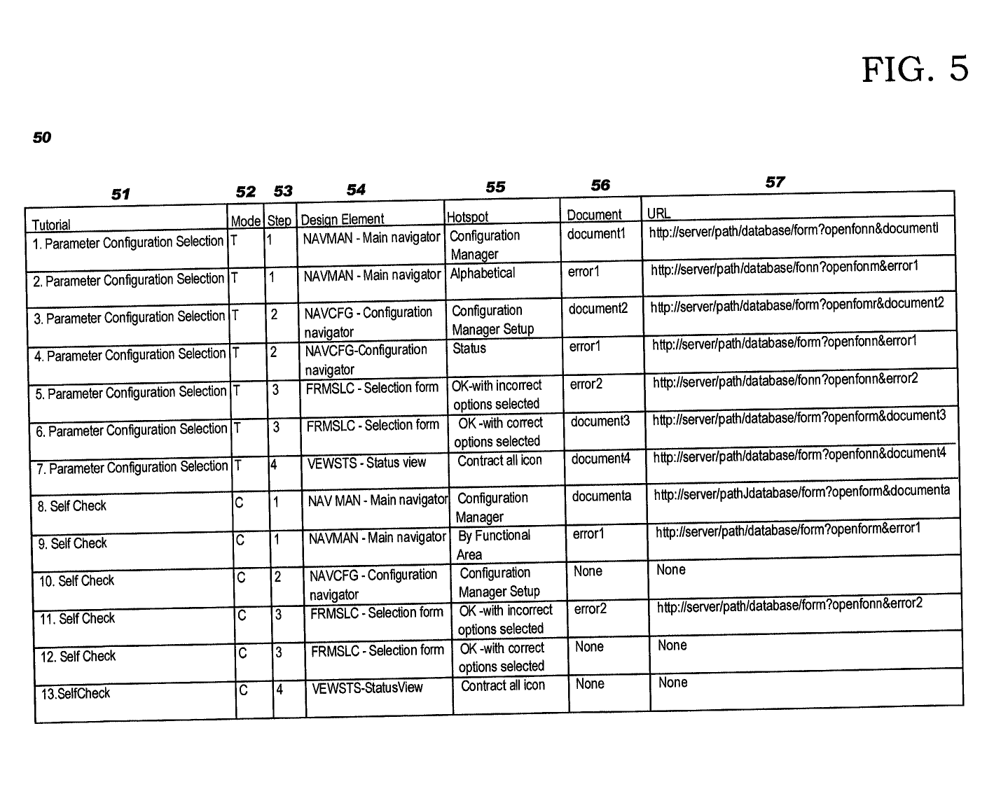

The method is also explained with reference to an example look up table 50 shown in FIG. 5. The table 50 includes columns for all the parameters which are used to determine a relevant help page relating to the portion of the tutorial which the applicant is using. The table 50 includes a column 51 for the tutorial type, which in this case is the parameter configuration selection tutorial, a column 52 for the help mode, a column 53 relating to the step in the tutorial, and a column 54 specifying the relevant help document filename. For illustrative purposes the entire URL to a relevant document is shown in another column 55, although in the preferred embodiment storage of the entire URL reference is not required, as will be described below. It should be appreciated that this is only an example table and contains a small portion of the likely parameters to be stored in a look up table. For example, the tutorial column 51 would generally contain a number of different tutorial types, there could also be several steps related to each design element, more than two help modes may exist, several more parameter columns as required and/or more than one help document may be specified for any one set of parameters.

Referring to FIG. 3, once an action has been performed by a user the application 13 retrieves, from a configuration file, a default URL which specifies a path to a higher level directory under which all the help documents are stored (Step 30). The configuration file may be stored on the system 10 in any suitable manner known to one skilled in the art. In the example shown in FIG. 5, the default URL is http://server/path/database/form?openform&. The application 13 then retrieves the user profile parameters (Step 32), that is, the tutorial type and help mode, from the profile file. The application 13 also monitors and determines in Step 32 the current design element and step in the tutorial reached by the user. At this point all the retrieved parameters are used by the application 13 to find a relevant help document from the look up table shown in FIG. 5 (Step 34). For example, if the user is participating in the “parameter configuration selection tutorial” has requested a “full tutorial” help mode and has performed an action to take them to the first step under a main navigator (introduction page) design element, then the application 13 retrieves the document name “document1” from the table 50. If no such document is available, for example as shown in rows 6, 7 and 9 of the table 50, then no reference is determined and no document is displayed (Step 25 in FIG. 2).

Otherwise, as shown in FIG. 4, the application 13 appends the specified document file name to the default URL in Step 40 to produce a full URL reference to a relevant help document. This full URL is sent to the browser 14 in Step 41 which subsequently retrieves the relevant help pages in Step 42 from the HTML database 17 through the intranet or Internet as applicable. The means of retrieving these pages through the HTTP server 18 will be well known those skilled in this area of technology and need not be explained in detail. Once the HTML help pages have been retrieved the browser 14 displays them for viewing and navigation by the user (Step 43). It will be appreciated that a default URL is not necessary and the entire URL or other reference type could be stored in the look up table 50 rather than storing document IDs or filenames which get appended to the default URL.

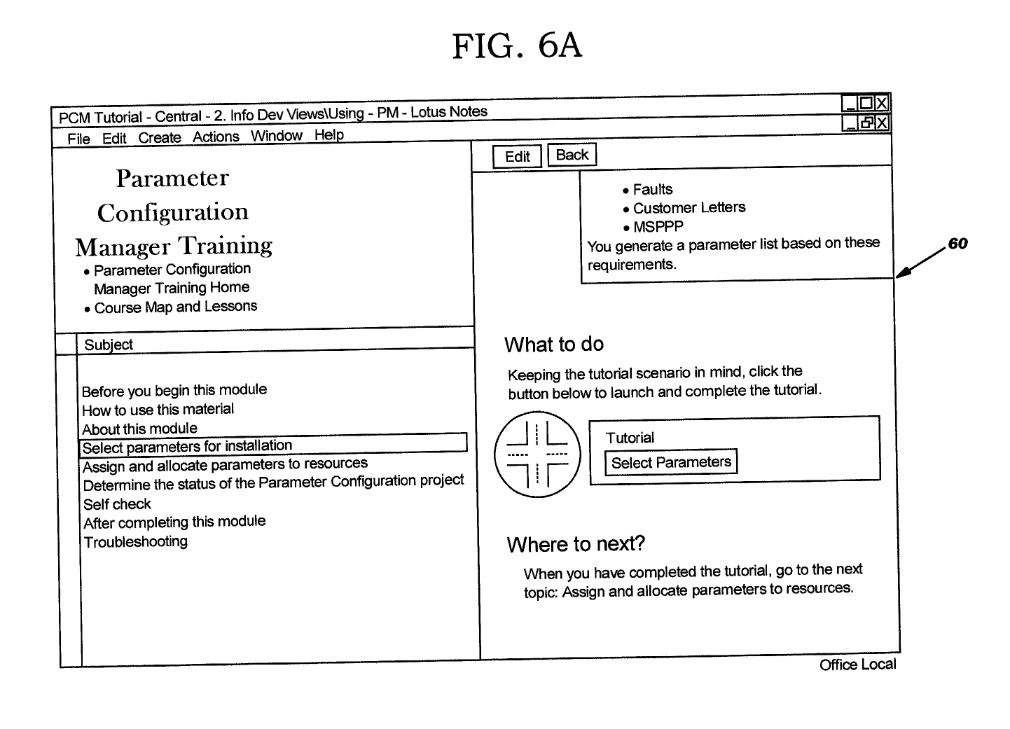

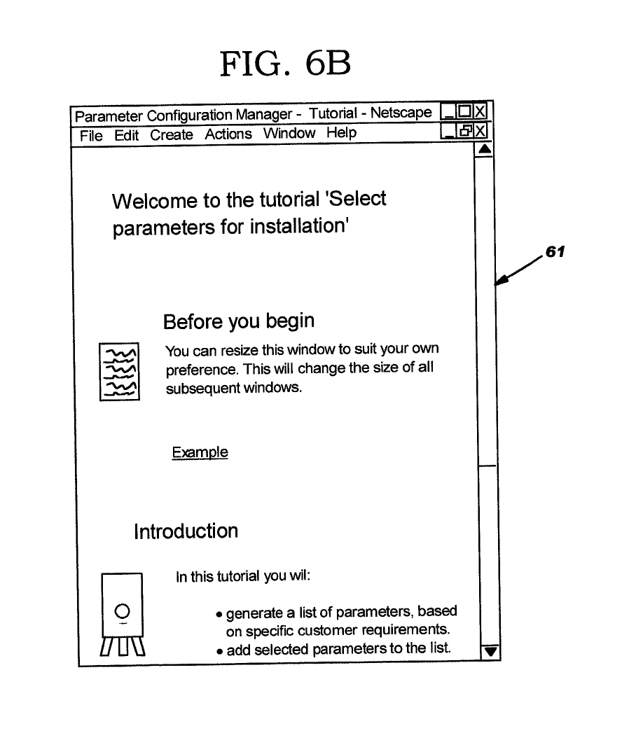

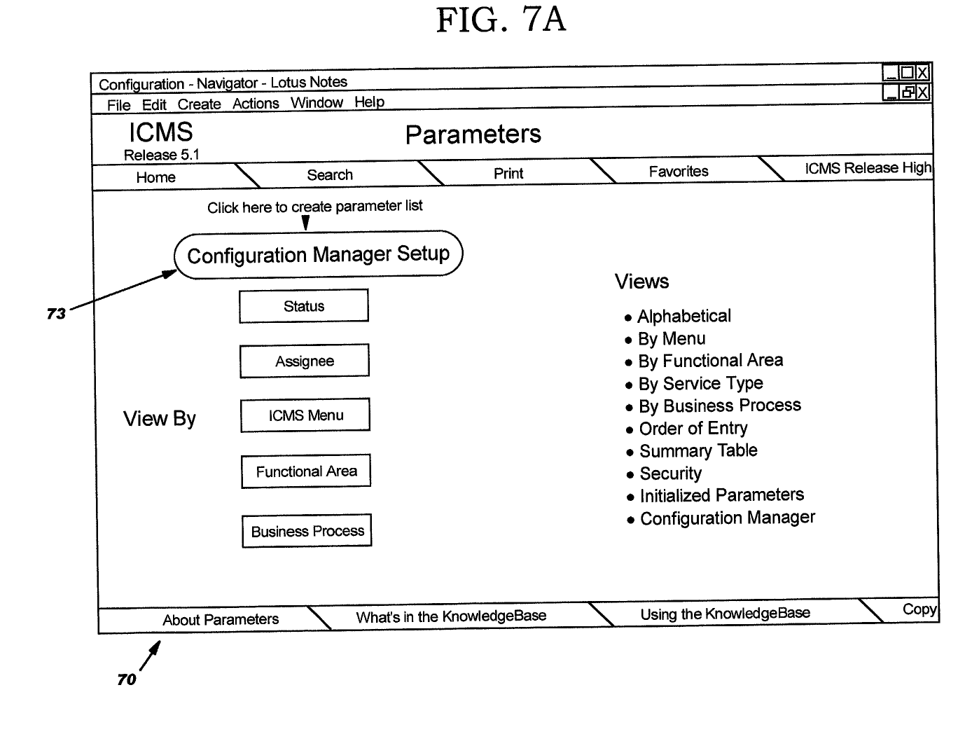

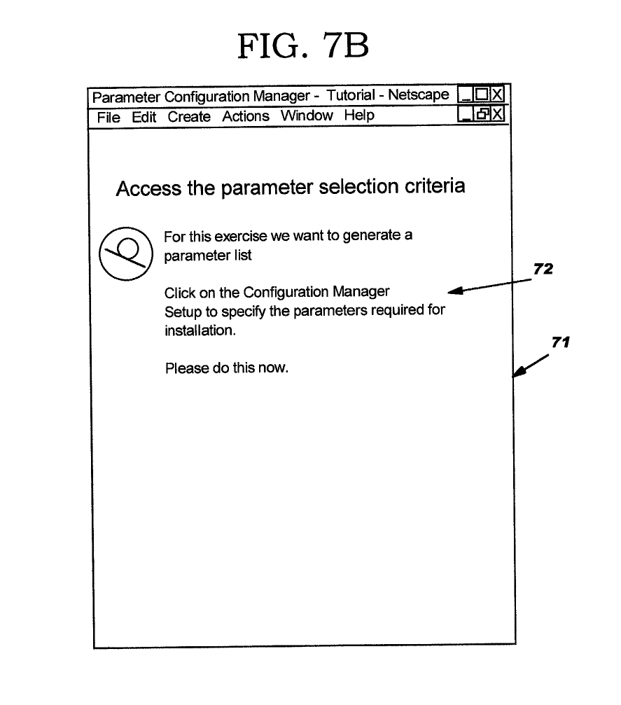

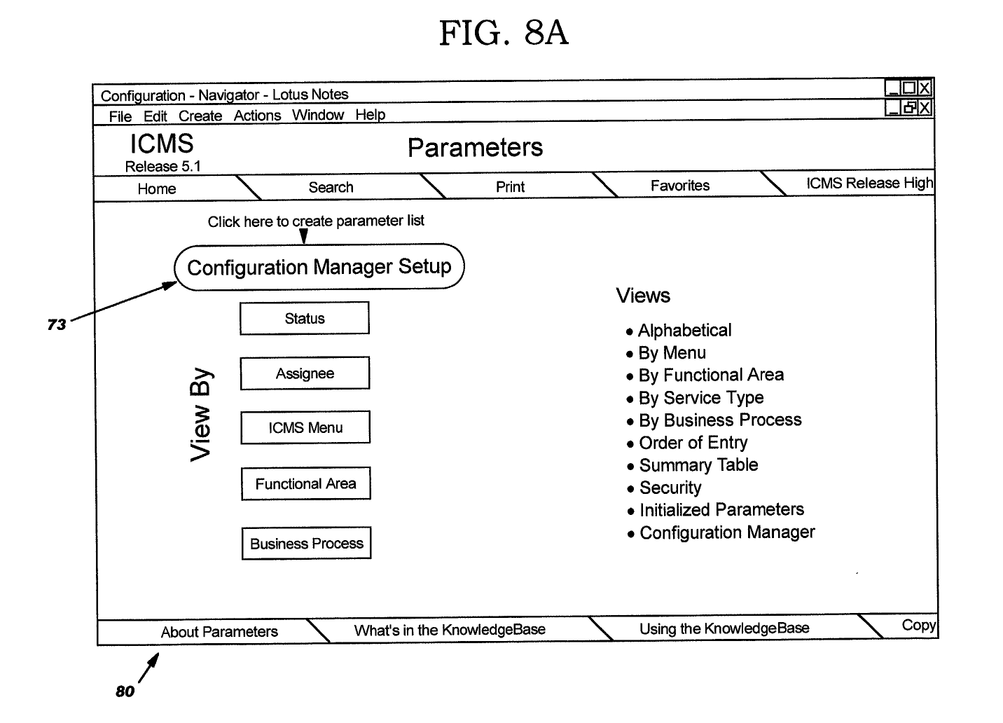

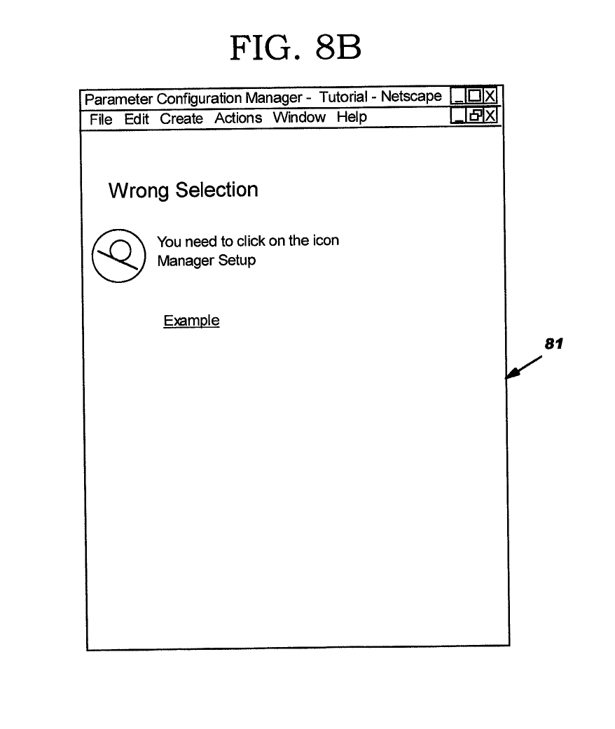

The present invention will now be described more specifically in relation to a selection of the database tutorial pages with reference to FIGS. 6a to 12b, which show some screens that are displayed during operation of the client software 12. FIG. 6a shows a main navigator page 60 which is displayed upon selecting the required tutorial, in this case the parameter configuration tutorial, and selecting the “full tutorial” help mode. The application 13 then uses the look up table 50 to determine the appropriate “full tutorial” help page 61 (FIG. 6b) corresponding to step 1 of the main navigator page in the parameter configuration tutorial. The URL http://server/path/database/form?openform&document1 is generated and utilised to retrieve the help page 61 which is then displayed in the browser 14, as shown in FIG. 6b. The application 13 then displays the next window 70, which is the configuration navigator shown in FIG. 7a. The relevant help page 71, which is specified in line two of the look up table, is displayed as shown in 7b and provides instructions 72 to the user on how to proceed, in this case to press the “configuration manager setup” 73 icon at the top of the configuration navigator page 70. FIG. 8a shows a screen shot where an incorrect selection has been made by the user, namely the “status” icon 80 has been selected instead of the “configuration manager setup” icon 73. FIG. 8b shows the retrieved help page 81 which is displayed advising the user that an incorrect selection has been made.

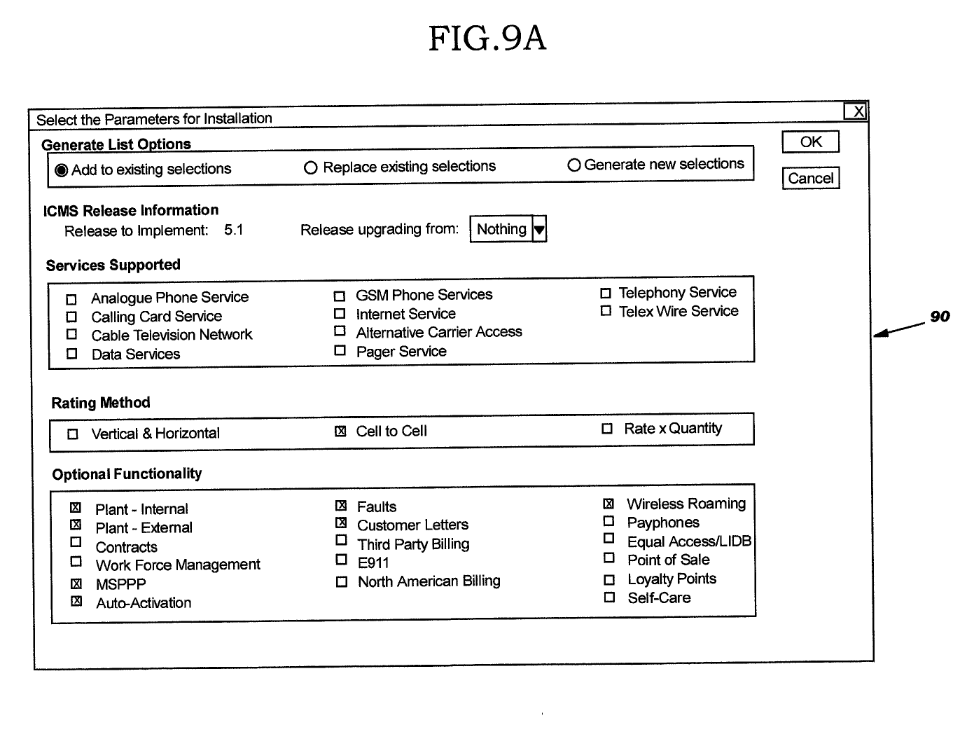

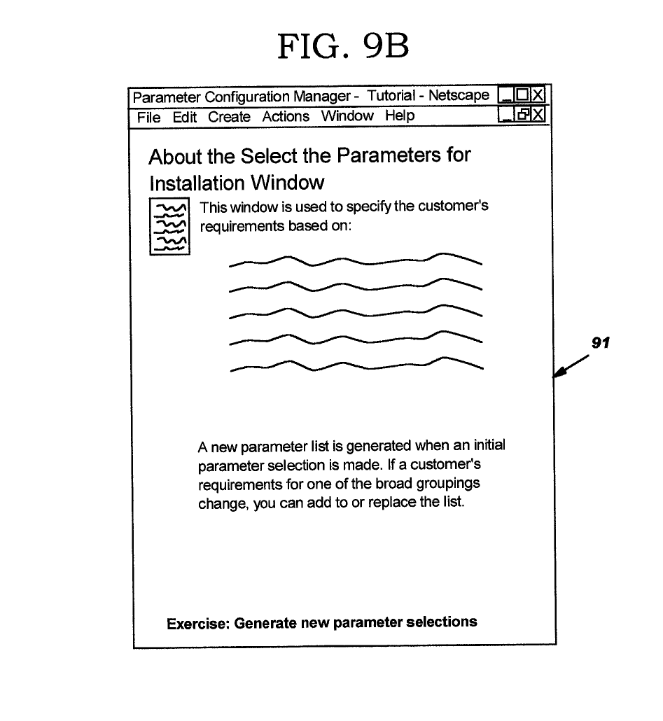

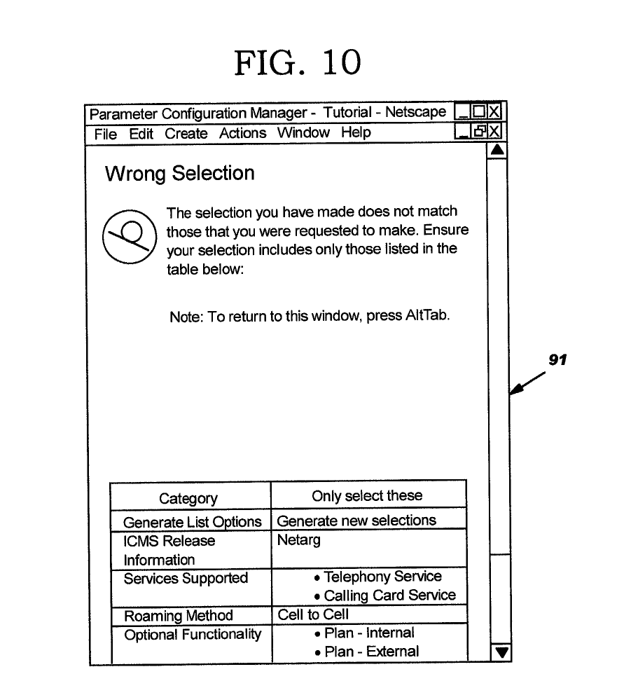

Once the correct icon has been clicked, the parameter selection form 90 is displayed as shown in FIG. 9a. FIG. 9b shows the relevant help page 91, determined by line three of the look up table 50, which guides the user through the parameter selection process. If an incorrect selection is made then the help page 92 shown in FIG. 10 displays the appropriate information which advises the user on the correct options to select.

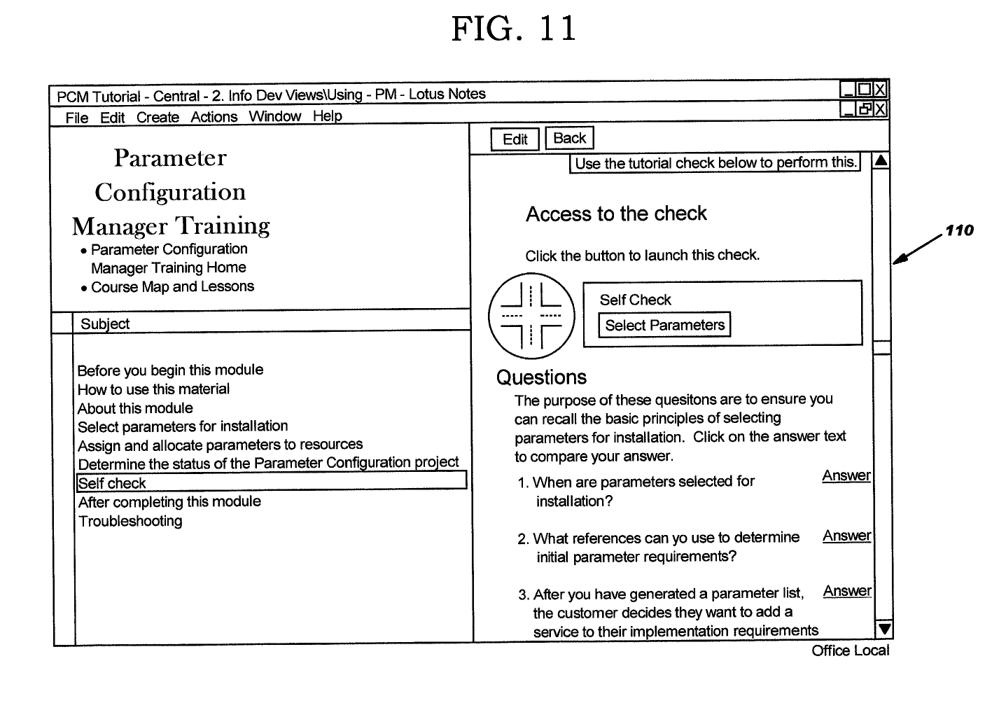

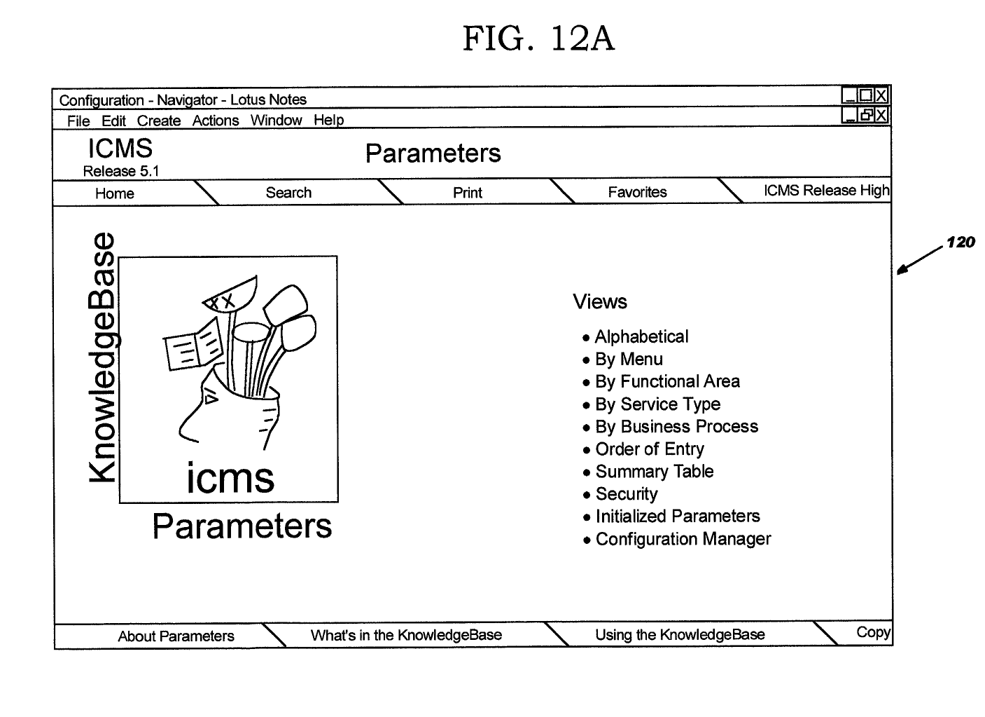

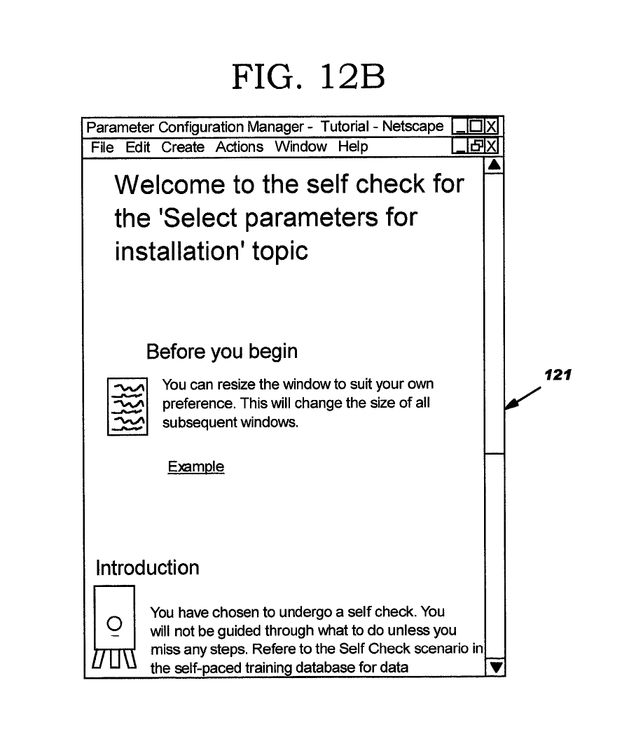

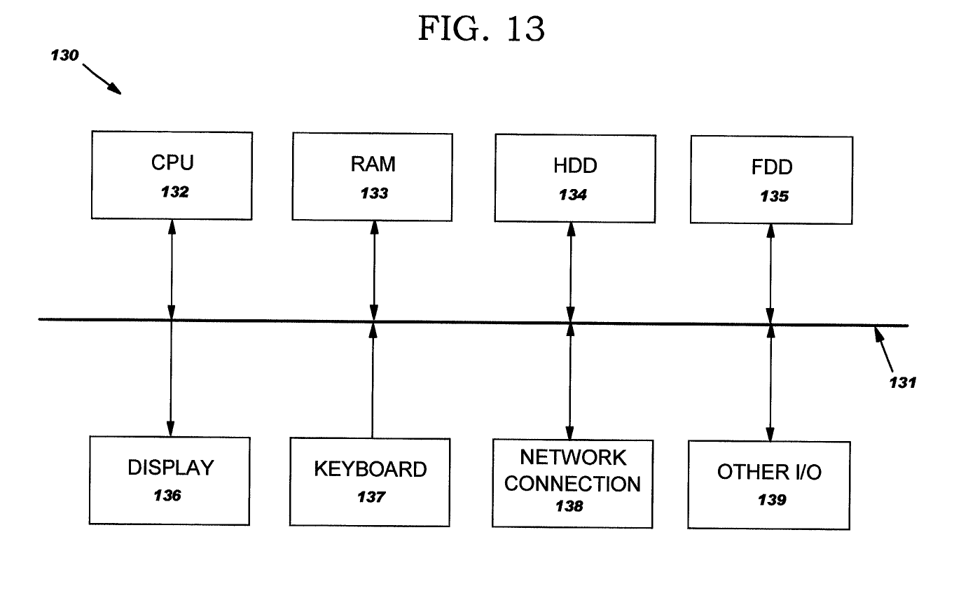

FIG. 11 shows the screen 110 displayed by the application 13 if the “self check” help mode is selected. As shown in FIGS. 12a and 12b, the next page 120 of the application 13 is shown along with the relevant help page 121 which is specified by row 5 of the look up table 50. The help page 121 indicates that “self check” mode has been selected and therefore no help pages will be retrieved and displayed in the browser 14 unless an error occurs. As can be seen from rows 6, 7 and 9 of the look up table, no help documents are specified for the steps of the tutorial under usual circumstances. If an incorrect action is performed, for example selecting the wrong options in the selection form, then an appropriate help page is retrieved and displayed, for example as specified in row 8 of the look up table 50.

It will be appreciated that the steps described and pages displayed are just a selection of those which the client software 12 provides. It will also be appreciated that the look up table 50 can contain as many entries as required to specify any necessary number of contextual help pages. The look up table 50 can also be adapted for use with any computer application to provide contextual help. The columns of the table 50 may be adapted in accordance with the nature of the application and any user specified parameters relating to the nature of the help pages. This enables help pages to be displayed automatically by an application as it is used without the need for the user to call up help pages in the usual manner, such as through a help menu.

FIG. 13 shows an example of a client computer 130 which forms part of the system for implementing the invention. The system 130 includes a databus 131 which interconnects a CPU 132, RAM 133, monitor or other display 136, keyboard 137, network connection 138 and other input/output components 139. The system 130 has a storage device such as a hard disk drive 134 for storing information and/or computer code as required. The system 130 also includes reading devices for a computer readable medium such as a floppy disk drive 135, CD-ROM drive or any other device, which will be known to those skilled in the art. Code for the client software 12 can be stored on floppy disk, CD-ROM or other suitable computer readable medium for loading into the system's RAM 133 or onto the hard drive 134 as required.

What we claim is:

1. A method for providing a user with help information during operation of a computer application, said method comprising the steps of:
detecting operation of a function of the application by the user;
determining a location reference to a stored document containing help information relating to the function;
retrieving the document from a storage location using the reference; and
displaying content from the document.

2. A method according to claim 1, wherein the reference is determined using a look up table which associates functions of the application with references to stored documents containing help information relating to a respective function.

3. A method according to claim 2, wherein the look up table associates the application functions to the references by way of one or more parameters.

4. A method according to claim 3, wherein the parameters relate to characteristics of the application and one or more user specified options.

5. A method according to claim 1, wherein the reference is a URL and the document is stored in a mark up language.

6. A method according to claim 4, wherein the application is a database tutorial and the parameters relate to tutorial type, current step in the tutorial, current user display type and a user specified help mode.

7. A method according to claim 6, wherein the document is displayed in a browser.

8. A computer application which provides a user with help information during operation of the application comprising:
a monitoring facility for detecting operation of an application function by the user;
a reference generator for determining a location reference to a stored document containing help information relating to the application function;
a retrieval function for retrieving the stored document from a storage location using the location reference; and
a graphical interface for displaying content from the stored document.

9. An application according to claim 8, wherein the reference generator includes a look up table which associates functions of the application with references to stored documents containing help information relating to a respective function.

10. An application according to claim 9, wherein the look up table associates the application functions to the references by way of one or more parameters.

11. An application according to claim 10, wherein the parameters relate to characteristics of the application and user specified options.

12. An application according to claim 8, wherein the reference is a URL and the document is stored in a mark up language.

13. An application according to claim 11, further comprising a database tutorial, wherein the parameters relate to tutorial type, current step in the tutorial, current user display type and a user specified help mode.

14. An application according to claim 13, wherein the graphical interface is in the form of a browser.

15. A computer readable medium containing computer code for an application which provides a user with help information, said code enabling the steps of:
detecting operation of an application function by the user;
determining a location reference to a stored document containing help information relating to the application function;
retrieving the document from its storage location using the reference; and
displaying content from the document.

16. A computer readable medium according to claim 15, wherein the reference is determined using a look up table which associates functions of the application with references to stored documents containing help. information relating to respective functions.

17. A computer readable medium according to claim 16, wherein the look up table associates the application functions to the references by way of one or more parameters.

18. A computer readable medium according to claim 17, wherein the parameters relate to characteristics of the application and user specified options.

19. A computer readable medium according to claim 15, wherein the reference is a URL and the document is stored as a mark up language.

20. A computer readable medium according to claim 18, wherein the application is a database tutorial and the parameters relate to tutorial type, current step in the tutorial, current user display type and a user specified help mode.

21. A computer readable medium according to claim 20, wherein the document is displayed in a browser.
